(19) United States
(12) Patent Application Publication
(10) Pub. No.: US 2014/0239601 A1
(43) Pub. Date: Aug. 28, 2014

(54) Roll Control

(71) Applicant: David Monroe Campbell, Wewoka, OK (US)

(72) Inventor: David Monroe Campbell, Wewoka, OK (US)

(21) Appl. No.: 14/186,584

(22) Filed: Feb. 21, 2014

Related U.S. Application Data
(60) Provisional application No. 61/768,837, filed on Feb. 25, 2013.

(51) Int. Cl. B60G 21/02

(52) U.S. Cl. CPC B60G 21/026
USPC 280/5.508; 280/124.106

(57) ABSTRACT

Various embodiments of a sway control system are disclosed. Various embodiments may have pivoting or sliding control arms. Said control arms are operatively coupled to a plurality of ground-engaging elements, of a vehicle, via connecting rods. A dampening and or or cushioning element employed in the assembly comprised of said control arm, said connecting rods, and said ground engaging elements to give the assembly the characteristics best suited for the particular vehicle application. Embodiments may have mechanical, spring, hydraulic, pneumatic, friction other developed dampening or cushioning elements employed as needed to achieve optimum performance for application. Some embodiments may provide for active control of the degree cushioning and or dampening available in said assembly.

### TECHNICAL FIELD

This document relates to vehicle suspensions and, more particularly, to controlling the mount of sway or body roll.

### BACKGROUND

Stabilizer bars are the common solution to adverse roll or sway in vehicles. Stabilizer bars are designed to counteract centrifugal forces when cornering on a vehicle, such as ATVs, passenger cars, and utility vehicles. Weight, cost, and inability to accurately control the effects, are all drawbacks of the typical sway bar.

### SUMMARY

Various embodiments of a sway control system are disclosed. The apparatus consists of an assembly comprised of a control arm coupled to the suspension by a plurality of connecting rods. The connection rods serve to transfer force from a ground engaging element of a vehicle to the control arm which in turn effects movement of other connecting rods also attached to said control arm. Since each of these control arms are also connected to a ground engaging device of said vehicle the force is efficiently transferred to the desired ground engaging device. Any number or types of dampening or cushioning devices may also be included in this assembly as needed to achieve optimum handling of a particular vehicle. One or more of said cushioning or dampening devices may be actively controlled as needed to achieve desired results.

Certain implementations may have one or more of the following advantages. Some embodiments may provide for active control of the degree of force transfer from one ground-engaging element's suspension system to the other. Some embodiments may provide for easy manual adjustment of the degree of force transfer. Some embodiments may provide multiple ways of adjusting torque transfer, allowing a vehicle operator to choose which way is most suitable in a given situation. Some embodiments may provide for integration of other suspension components such as shocks and springs. These may be connected directly to said connecting rods or said control arm or alternatively my employ additional connecting rods or levers to achieve optimum results for the particular application.

### BRIEF DESCRIPTION OF THE DRAWINGS

FIG. 1 shows a perspective view of an exemplary independent suspension system for a vehicle using a roll control assembly utilizing of a sliding type of control arm.

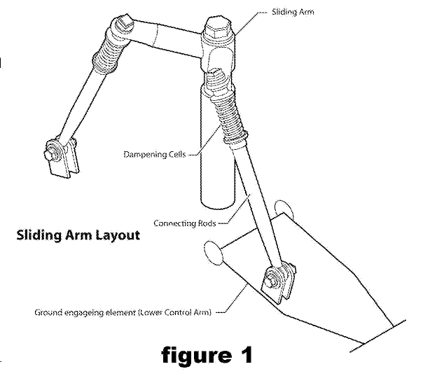

FIG. 2 shows a perspective view of an exemplary independent suspension system for a vehicle using a roll control assembly utilizing of a pivoting type of control arm.

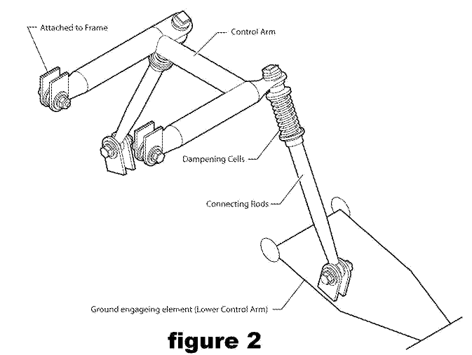

FIG. 3 shows an exemplary independent suspension system for a vehicle using a roll control assembly utilizing of a pivoting type of control arm.

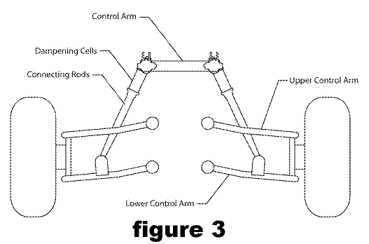

FIG. 4 shows an exemplary independent suspension system for a vehicle using a roll control assembly utilizing of a sliding type of control arm.

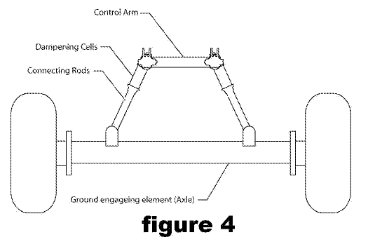

Thus, embodiments of the sway control system are disclosed. One skilled in the art will appreciate that the sway control system invention can be practiced with embodiments other than those disclosed. The disclosed embodiments are presented for purposes of illustration and not limitation, and the present invention is limited only by the claims that follow.

1. A sway control system, comprising:
a plurality of connecting rod members, each adapted to be operatively coupled to a respective, ground-engaging element of a vehicle, and also to a control arm, said control arm is mounted in such a way as to allow it to move freely vertically but prohibiting lateral and horizontal movement in relation to the chassis of said vehicle.

2. The sway control system of claim 1, further comprising a dampening and or cushioning device in one or more locations to effect the control of force transmitted via said assembly.

3. The sway control system of claim 1, further comprising a manually adjustable dampening and or cushioning device in one or more locations to effect the control of force transmitted via said assembly.

4. The sway control system of claim 1, further comprising a actively adjustable dampening and or cushioning device in one or more locations to effect the control of force transmitted via said assembly.

5. to sway contra system of claim 1, where said control arm is a pivoting arm mounted above said ground engaging elements.

6. A sway control system, comprising:
a plurality of connecting rod members, each adapted to be operatively coupled to a respective, ground-engaging element of a vehicle, and also to pivoting control arms, said control arms are connected to each other in a rigid manner and are mounted in such a way as to allow them to move freely vertically, but prohibiting lateral and horizontal movement in relation to the chassis of said vehicle.

7. The sway control system of claim 6, further comprising a dampening and or cushioning device in one or more of said connecting rods to effect the control of force transmitted via said assembly.

8. The sway control system of claim 6, further comprising a manually adjustable dampening and or cushioning device in one or more of said connecting rods to effect the control of force transmitted via said assembly.

9. The sway control system of claim 6, further comprising a actively adjustable dampening and or cushioning device in one or more of said connecting rods to effect the control of force transmitted via said assembly.
